(19) United States
(12) Patent Application Publication
(10) Pub. No.: US 2024/0419885 A1
(43) Pub. Date: Dec. 19, 2024

(54) HYBRID MODELING FOR FILM METROLOGY

(71) Applicant: Tokyo Electron Limited, Tokyo (JP)

(72) Inventors: Yan CHEN, Fremont, CA (US); Vi VUONG, Fremont, CA (US); Xinkang TIAN, Fremont, CA (US); Francisco MACHUCA, Fremont, CA (US)

(73) Assignee: Tokyo Electron Limited, Tokyo (JP)

(21) Appl. No.: 18/535,103

(22) Filed: Dec. 11, 2023

Related U.S. Application Data
(60) Provisional application No. 63/521,757, filed on Jun. 19, 2023.

(51) Int. Cl. G06F 30/398; G06F 119/18

(52) U.S. Cl. CPC G06F 30/398; G06F 2119/18

(57) ABSTRACT

A method of film thickness modeling includes receiving optical data of a sample having a top layer and at least one underlying layer. First simulation data are obtained by inputting the optical data into a multi-layer model. When a GOF of the first simulation data is below a threshold, a simulated thickness is obtained by inputting the optical data into a top-layer model that is substantially unaffected by the at least one underlying layer. A starting point of the thickness of the multi-layer model is adjusted based on the simulated thickness. Second simulation data are obtained by inputting the optical data into the multi-layer model. When the GOF of the second simulation data is below the threshold, the starting point of the thickness in the multi-layer model is re-adjusted, and third simulation data are obtained by inputting the optical data into the multi-layer model.

### INCORPORATION BY REFERENCE

This present disclosure claims the benefit of U.S. Provisional Application No. 63/521,757, filed on Jun. 19, 2023, which is incorporated herein by reference in its entirety. Aspects of the present disclosure are related to U.S. patent application Ser. No. 18/501,672, filed on Nov. 3, 2023, which is incorporated herein by reference in its entirety.

### FIELD OF THE INVENTION

This disclosure relates generally to film metrology and more specifically to a method of determining film thickness.

### BACKGROUND

In the manufacture of a semiconductor device (especially on the microscopic scale), various fabrication processes are executed such as film-forming depositions, etch mask creation, patterning, material etching and removal, and doping treatments. These processes are performed repeatedly to form desired semiconductor device elements on a substrate. Key to these processes are film thickness control and film uniformity control. Therefore, various film thickness characterization techniques have been developed and used in the semiconductor industry.

### SUMMARY

The present disclosure relates to a method of determining film thickness and an apparatus for executing the same.

According to a first aspect of the disclosure, a method for determining film thickness is provided. The method includes receiving optical data of a sample. The sample has a plurality of layers including a top layer and at least one underlying layer. First simulation data are obtained by simulating a multi-layer model configured to simulate the thickness of the top layer and comparing it to the optical input data. When a goodness of fit (GOF) of the first simulation data is below a threshold, a simulated thickness is obtained by inputting the optical data into a top-layer model that is configured to simulate a thickness of the top layer and is substantially unaffected by the at least one underlying layer. A starting point of the thickness of the multi-layer model is adjusted based on the simulated thickness. Second simulation data are then obtained by inputting the optical data into the multi-layer model. When a GOF of the second simulation data is above the threshold, the thickness is output based on the second simulation data, or when the GOF of the second simulation data is below the threshold, (a) the starting point of the thickness in the multi-layer model is re-adjusted, and (b) third simulation data are then obtained by inputting the optical data into the multi-layer model.

In some embodiments, (a) and (b) are repeated until a GOF of the third simulation data is above the threshold.

In some embodiments, (a) includes reducing the starting point of the thickness in the multi-layer model.

In some embodiments, when a GOF of the third simulation data is below the threshold, an adjusted multi-layer model is received in which a fixed constant of the multi-layer model is changed to a variable, a variable of the multi-layer model is changed to a fixed constant, or a combination thereof.

In some embodiments, fourth simulation data are obtained by inputting the optical data into the adjusted multi-layer model.

In some embodiments, when a GOF of the fourth simulation data is below the threshold, a starting point of the thickness of the adjusted multi-layer model is adjusted based on the simulated thickness. Fifth simulation data are then obtained by inputting the optical data into the adjusted multi-layer model.

In some embodiments, when a GOF of the fifth simulation data is below the threshold, (c) the starting point of the thickness of the adjusted multi-layer model is re-adjusted, and (d) sixth simulation data are then obtained by inputting the optical data into the adjusted multi-layer model.

In some embodiments, (c) and (d) are repeated until a GOF of the sixth simulation data is above the threshold.

In some embodiments, in the multi-layer model, at least one thickness of the at least one underlying layer is a fixed constant, and in the adjusted multi-layer model, the at least one thickness of the at least one underlying layer is a variable.

In some embodiments, GOFs of the first and second simulation data are obtained with a cost function which outputs the GOFs of the first and second simulation data.

In some embodiments, a library including historic data and historic models including the multi-layer model is received. In some embodiments, a library of multiple sub-libraries including historic data and historic models including the multi-layer model and the adjusted multi-layer model is received.

In some embodiments, the multi-layer model is chosen from the library by calculating GOFs between the optical data and the historical data and identifying a largest GOF.

In some embodiments, the optical data are added to the library when the optical data have a distance larger than a threshold distance from the historic data of the library.

In some embodiments, the optical data include reflectance spectra. A library size is reduced by reducing the number of wavelengths in the reflectance spectra.

In some embodiments, the top-layer model includes performing a Fourier Transform (FT) of the optical data to obtain an FT spectrum and determining the thickness based on a primary peak of the FT spectrum which has a highest value in the FT spectrum.

In some embodiments, the optical data of the sample includes optical data of reflectance versus wavelength.

In some embodiments, receiving the optical data of the sample includes measuring the sample to obtain measurement data of intensity versus wavelength and converting the measurement data of intensity versus wavelength to the optical data of reflectance versus wavelength.

In some embodiments, the multi-layer model is an ellipsometry model.

In some embodiments, the top layer includes silicon, and the at least one underlying layer includes silicon oxide and another layer.

According to a second aspect of the disclosure, an apparatus is provided. The apparatus includes a controller including a processor that is programmed to receive optical data of a sample. The sample has a plurality of layers including a top layer and at least one underlying layer. First simulation data are obtained by simulating a multi-layer model configured to simulate the thickness of the top layer and comparing it to the optical input data. When a goodness of fit (GOF) of the first simulation data is below a threshold, a simulated thickness is obtained by inputting the optical data into a top-layer model that is configured to simulate a thickness of the top layer and is substantially unaffected by the at least one underlying layer. A starting point of the thickness of the multi-layer model is adjusted based on the simulated thickness. Second simulation data are then obtained by inputting the optical data into the multi-layer model. When a GOF of the second simulation data is above the threshold, the thickness is output based on the second simulation data, or when the GOF of the second simulation data is below the threshold, (a) the starting point of the thickness in the multi-layer model is re-adjusted, and (b) third simulation data are then obtained by inputting the optical data into the multi-layer model.

Note that this summary section does not specify every embodiment and/or incrementally novel aspect of the present disclosure or claimed invention. Instead, this summary only provides a preliminary discussion of different embodiments and corresponding points of novelty. For additional details and/or possible perspectives of the invention and embodiments, the reader is directed to the Detailed Description section and corresponding figures of the present disclosure as further discussed below.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be increased or reduced for clarity of discussion.

FIG. 1 shows a diagram of film thickness metrology in accordance with some embodiments of the present disclosure.

FIG. 2 shows a flow chart of regressions to obtain a thickness in accordance with some embodiments of the present disclosure.

FIG. 3 shows a flow chart of building a library in accordance with some embodiments of the present disclosure.

FIG. 4 shows a flow chart of identifying the best-match model in accordance with some embodiments of the present disclosure.

FIGS. 5A and 5B show optical data at different wafer locations in accordance with some embodiments of the present disclosure.

FIGS. 6A and 6B show optical data output by different simulation models in accordance with some embodiments of the present disclosure.

FIGS. 7A and 7B show optical data output by different simulation models in accordance with some embodiments of the present disclosure.

FIG. 8 shows a vertical cross-section of a wafer, in accordance with some embodiments of the present disclosure.

FIG. 9 shows a flow chart of a process for determining film thickness, in accordance with some embodiments of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed. Further, spatially relative terms, such as “top,” “bottom,” “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

The order of discussion of the different steps as described herein has been presented for clarity's sake. In general, these steps can be performed in any suitable order. Additionally, although each of the different features, techniques, configurations, etc. herein may be discussed in different places of this disclosure, it is intended that each of the concepts can be executed independently of each other or in combination with each other. Accordingly, the present invention can be embodied and viewed in many different ways.

In the drawings, like reference numerals designate identical or corresponding parts throughout the several views. Additionally, as used herein, the words “a”, “an” and the like generally carry a meaning of “one or more”, unless stated otherwise.

Furthermore, the terms, “approximately”, “approximate”, “about” and similar terms generally refer to ranges that include the identified value within a margin of 20%, 10%, or preferably 5%, and any values therebetween.

Thin film optical metrology is one of the cornerstones of semiconductor manufacturing processes. The current technology of choice is based on spectroscopic analysis of reflections from a thin film and includes spectroscopic reflectometry (SR) and ellipsometry (SE), both of which are widespread technologies due to best-in-class sensitivity, high throughput, reasonable cost, and non-destructive measurement capability. Spectroscopic analysis normally requires information about and assumptions to be made about the layer stack and the structures formed on a wafer such that a multi-layer model of the sample structure can be built. Such a multi-layer model typically takes into consideration a top layer of interest and at least one underlying layer. The multi-layer model is then used to generate synthetic spectra, which can be compared to measured spectra such that parameters of interest such as film thickness can be determined.

However, if information about layer thicknesses and structures formed within the layers is incomplete, then spectroscopic techniques may be unable to provide accurate measurement results. A similar disadvantage exists if optical properties of layers and structures are not known and/or difficult to obtain. Even with all necessary information available, it usually takes time and engineering effort to build and optimize a multi-layer model before one can be used for actual measurements. In Applicant's copending U.S. patent application Ser. No. 18/501,672, filed on Nov. 3, 2023, a top-layer model that is not based on or related to underlying layers and structures is developed to measure thin film thickness with nanometer-level sensitivity. The top-layer model allows for rapid and reasonably accurate thickness estimation without knowledge of the film stack or its nominal thickness(es).

Techniques herein provide a hybrid solution that combines dynamic library search technology, a top-layer model, and one or more multi-layer models to achieve fast global thickness regression, which is different from conventional local regressions within a limited thickness range. In traditional library methods, a pre-built library needs to cover the full variation and wavelength ranges, resulting in a large library. The pre-built library must be regenerated if the model's changed. Compared with traditional library methods, there is no need to pre-build a library and link to the analysis recipe, according to aspects of the present disclosure.

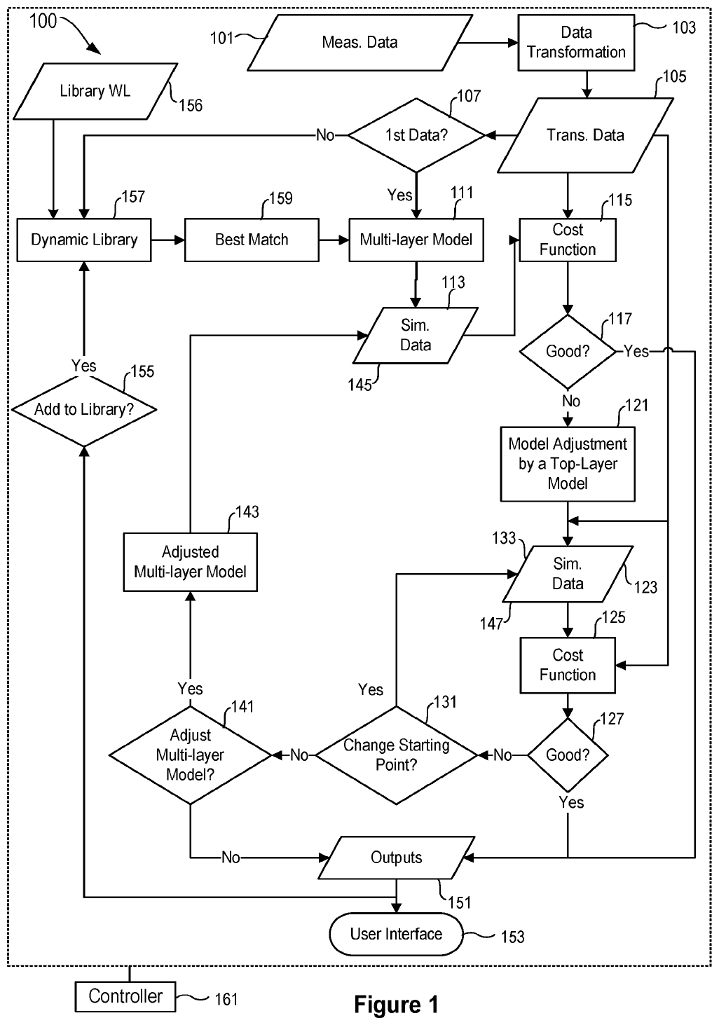

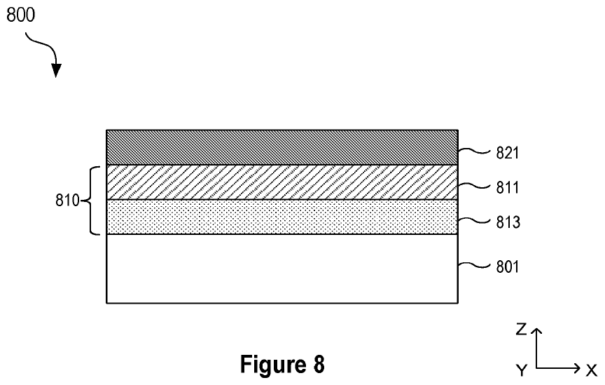

FIG. 1 shows a diagram of a process 100 of film thickness metrology, and FIG. 8 shows a vertical cross-section of a wafer 800, in accordance with some embodiments of the present disclosure. As shown, measurement data 101 are received from a third party or oneself. In step 103, data transformation is executed of the measured data 101 to obtain transformed data 105. For example, the measurement data 101 can include optical data of the wafer 800, such as intensity versus wavelength. The wafer 800 can have a plurality of layers including a top layer 821 and at least one underlying layer 810 over a substrate 801. The wafer 800 can be measured to obtain optical data of intensity versus wavelength, which can then be converted to the transformed data 105, such as reflectance versus wavelength.

In step 107, whether the transformed data 105 are the first data is determined. If the transformed data 105 are the first data, meaning that there are no prior data, the transformed data 105 are input into a multi-layer model 111 which is configured to output first simulation data 113 including a thickness of the top layer 821. The multi-layer model 111 can include information and assumptions regarding the top layer 821 and the at least one underlying layer 810, and optionally the substrate 801 as well.

In a non-limiting example, the at least one underlying layer 810 includes a first underlying layer 811 and a second underlying layer 813. Table 1 shows one embodiment of film composition of the wafer 800.

TABLE 1
One embodiment of film composition of the wafer 800

| Layer | Nominal Thickness (nm) | Material | Fixed? |
|---|---|---|---|
| 821 | 1000 | Si | No |
| 811 | 500 | SiO₂ | No |
| 813 | 100 | SiCN | Yes |
| 801 | N.A. | Si | N.A. |

As shown in Table 1, the multi-layer model 111 can include information and assumptions such as nominal thicknesses and film material of the top layer 821, the first underlying layer 811, the second underlying layer 813 and the substrate 801. The multi-layer model 111 can be a conventional Ellipsometry model built by methods known to a skilled artisan in the art.

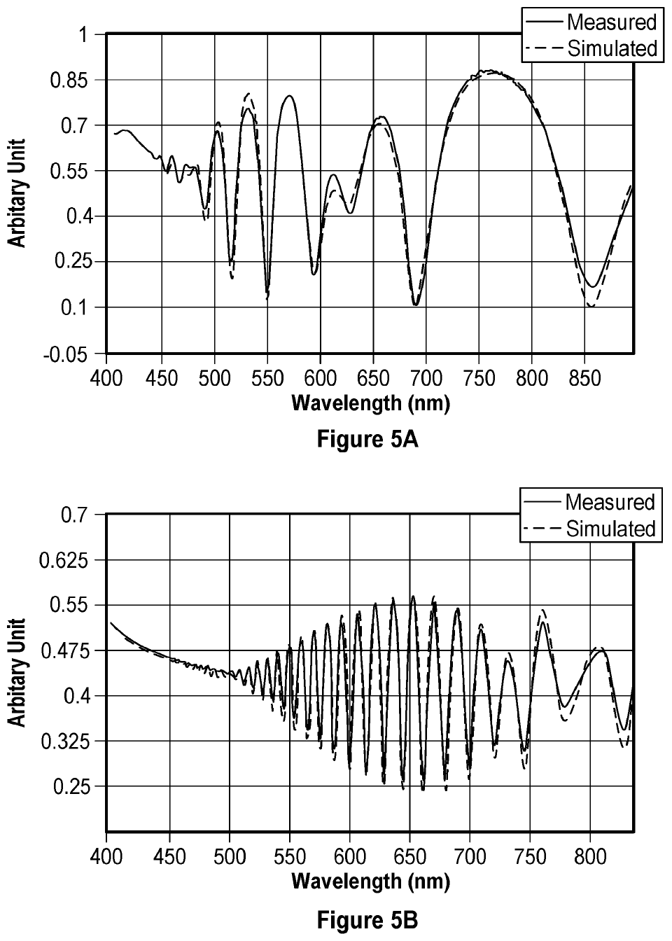

FIGS. 5A and 5B show optical data of reflectance versus wavelength at different wafer locations in accordance with some embodiments of the present disclosure. FIGS. 5A and 5B can respectively show film thicknesses of about 300 nm and 2500 nm at different locations on one common wafer such as the wafer 800. In both figures, “Measured” represents the transformed data 105 while “Simulated” represents the first simulation data 113 output by the multi-layer model 111. As can be seen, the transformed data 105 and the first simulation data 113 are in agreement with each other. It should be understood that the transformed data 105 and the first simulation data 113 may not always be in agreement with each other, depending on the specific location, local optical properties (e.g. complex refractive indices, n and k) and local thickness of the wafer 800.

In step 115, a cost function can be used to determine whether the first simulation data 113 are good. For example, when a goodness of fit (GOF) of the first simulation data 113 is above a threshold such as 0.95, the first simulation data 113 are considered good. The process 100 then proceeds to step 151 to output the thickness of the top layer 821 to a user interface 153.

When the GOF of the first simulation data 113 is below the threshold, the first simulation data 113 is considered not good. Subsequently in step 121, the transformed data 105 are input into a top-layer model that is configured to simulate a thickness of the top layer 821 and is substantially unaffected by the at least one underlying layer 810. As a result, a simulated thickness is output by the top-layer model. A starting point of the thickness (or a starting thickness) of the multi-layer model 111 can be reset or adjusted to be the simulated thickness. The transformed data 105 are then input into the multi-layer model 111, whose starting thickness has already been adjusted, to obtain second simulation data 123.

Note that the top-layer model may rely on information and knowledge of the top layer 821 without relying on information and knowledge of the at least one underlying layer 810 or the substrate 801. That is, the top-layer model may include no parameter or variable related to the at least one underlying layer 810 or the substrate 801. Note that the top layer 821 is a single layer in many embodiments. Accordingly, the top-layer model can be a single-layer model. However, in other embodiments, the top-layer model can be applicable to a thickness-dominant layer that is below the top layer 821 or a thickness-dominant layer that is part of the top layer 821. Additionally, the top-layer model can include performing a Fourier Transform (FT) of a reflectivity or reflectance spectrum to obtain an FT spectrum and determining the thickness of the top layer 821 based on a primary peak of the FT spectrum which has a highest intensity in the FT spectrum. The top-layer model is described in greater detail in Applicant's copending U.S. patent application Ser. No. 18/501,672, filed on Nov. 3, 2023.

In step 125, a cost function can be used to determine whether the second simulation data 123 is good. For example, when a GOF of the second simulation data 123 is above the threshold, the second simulation data 123 are considered good. The process 100 then proceeds to step 151 to output the thickness of the top layer 821 to the user interface 153.

When the GOF of the second simulation data 123 is below the threshold, the second simulation data 123 is considered not good. Subsequently in step 131, the starting point of the thickness in the multi-layer model 111 is re-adjusted, for example by reducing the starting point of the thickness. Then the transformed data 105 are input into the multi-layer model 111, whose starting thickness has already been re-adjusted, to obtain third simulation data 133.

In step 125, a cost function can then be used to determine whether the third simulation data 133 is good. Steps 125, 127, 131 and 133 may need to be repeated for the third simulation data 133 to be good. That is, the starting thickness of the multi-layer model 111 may need to be re-adjusted one or more times to output the third simulation data 133 whose GOF is above the threshold.

In some embodiments, it might be impracticable or undesirable to keep re-adjusting the starting thickness of the multi-layer model 111. Accordingly, the process 100 proceeds to step 141 in which whether to adjust the multi-layer model 111 is determined. When it is preferred not to adjust the multi-layer model 111, the process 100 proceeds to step 151.

If the multi-layer model 111 can be adjusted, an adjusted multi-layer model 143 is obtained. For instance, in the multi-layer model 111, at least one thickness of the at least one underlying layer 810 is a fixed constant while in the adjusted multi-layer model 143, the at least one thickness of the at least one underlying layer 810 is a variable.

In a non-limiting example, Table 2 and Table 3 respectively show the multi-layer model 111 and the adjusted multi-layer model 143.

TABLE 2
One embodiment of the multi-layer model 111

| Layer | Nominal Thickness (nm) | Material | Fixed? |
|---|---|---|---|
| 821 | 15,000 | Si | No |
| 811 | 250 | TEOS | Yes |
| 813 | 100 | SiO₂ | Yes |
| 801 | N.A. | Si | N.A. |

TABLE 3
One embodiment of the adjusted multi-layer model 143

| Layer | Nominal Thickness (nm) | Material | Fixed? |
|---|---|---|---|
| 821 | 15,000 | Si | No |
| 811 | 250 | TEOS | No |
| 813 | 100 | SiO₂ | No |
| 801 | N.A. | Si | N.A. |

As shown in Table 2, nominal thicknesses of the first underlying layer 811 and the second underlying layer 813 are fixed, that is, assumed to be known and treated as constants in the multi-layer model 111. By contrast in Table 3, the nominal thicknesses of the first underlying layer 811 and the second underlying layer 813 are not fixed, that is, assumed to be unknown and treated as variables in the adjusted multi-layer model 143.

The transformed data 105 can be input into the adjusted multi-layer model 143 to obtain fourth simulation data 145. The process 100 then proceeds to step 115 and step 117. When a GOF of the fourth simulation data 145 is below the threshold, a starting point of the thickness of the adjusted multi-layer model 143 can be adjusted based on the simulated thickness from the top-layer model in step 121. Then, the transformed data 105 can be input into the adjusted multi-layer model 143, whose starting thickness has already been adjusted, to obtain fifth simulation data 147. Similarly, the starting thickness of the adjusted multi-layer model 143 may need to be adjusted one or more times in step 131. In some embodiments, the adjusted multi-layer model 143 may need to be adjusted in step 141. For instance, the nominal thickness of the second underlying layer 813 may be changed back to be fixed while the nominal thickness of the second underlying layer 813 remains a variable.

Obtaining the adjusted multi-layer model 143 is not limited to changing the thickness controls (fix or float) of the multi-layer model 111. In some embodiments, other model properties of the multi-layer model 111, such as the complex refractive indices, n and k can be changed.

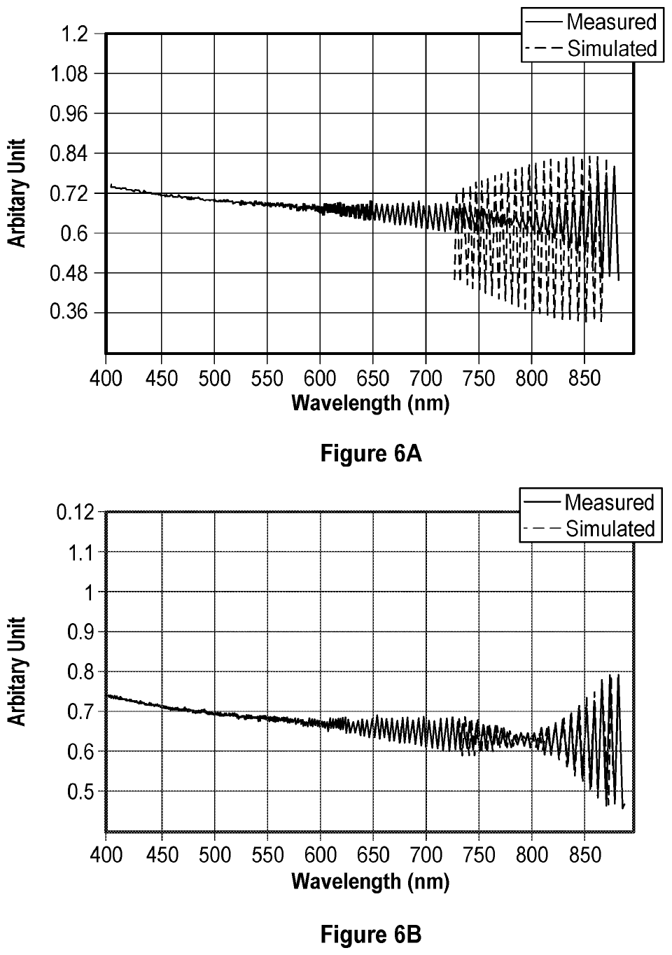

FIGS. 6A and 6B show optical data of reflectance versus wavelength at one location in accordance with some embodiments of the present disclosure. In both figures, “Measured” represents the transformed data 105. “Simulated” in FIG. 6A represents the first simulation data 113 output by the multi-layer model 111. “Simulated” in FIG. 6B represents the fourth simulation data 145 output by the adjusted multi-layer model 143. As can be seen, the transformed data 105 and the first simulation data 113 are not in agreement with each other while the transformed data 105 and the fourth simulation data 145 are in agreement with each other. That is, the adjusted multi-layer model 143 provides better simulation results than the multi-layer model 111.

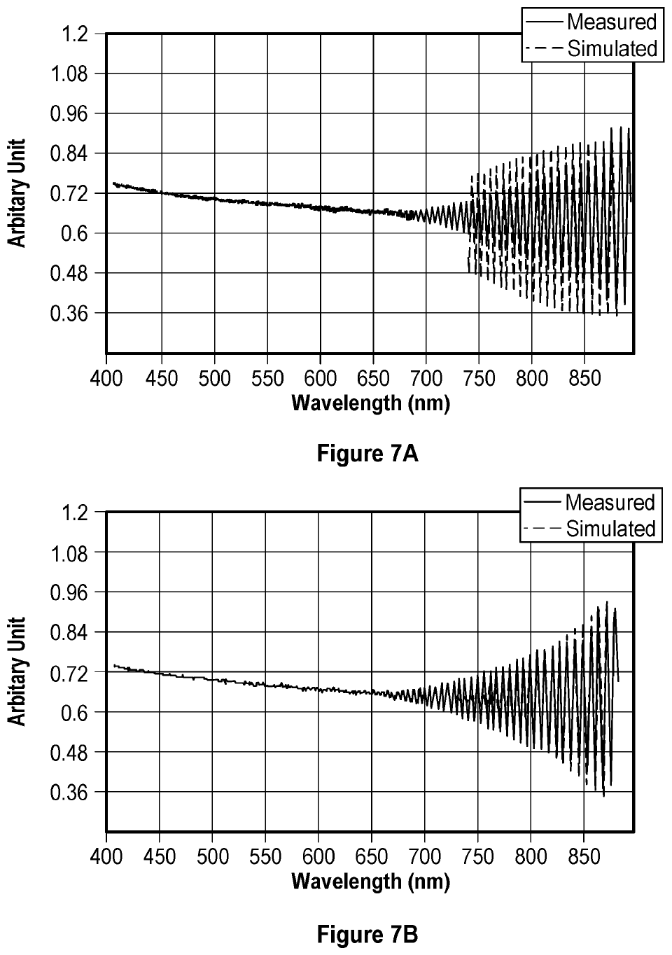

FIGS. 7A and 7B show optical data of reflectance versus wavelength at another location in accordance with some embodiments of the present disclosure. In both figures, “Measured” represents the transformed data 105. “Simulated” in FIG. 7A represents the first simulation data 113 output by the multi-layer model 111. “Simulated” in FIG. 7B represents the fourth simulation data 145 output by the adjusted multi-layer model 143. As can be seen, the transformed data 105 and the first simulation data 113 are in agreement with each other while the transformed data 105 and the fourth simulation data 145 are not in agreement with each other. That is, the multi-layer model 111 provides better simulation results than the adjusted multi-layer model 143.

As can be seen from FIGS. 6A, 6B, 7A and 7B, the multi-layer model 111 can provide good simulation results with GOF above the threshold for some data while the adjusted multi-layer model 143 can provide good simulation results with GOF above the threshold for other data. Depending on specific data, the multi-layer model 111 may be sufficient or may need to be adjusted. Given the thickness variations across a wafer as well as the large volume and variety of thickness data of various wafers in semiconductor manufacturing, a hybrid approach that combines a top-layer model, the multi-layer model 111 and the adjusted multi-layer model 143 is often necessary.

Referring back to FIG. 1, when simulation data (e.g. 113, 123, 133, 145 and 147) are considered good, the process proceeds to step 151 to output the thickness of the top layer 821 to the user interface 153. In some embodiments, whether the transformed data 105 corresponding to good simulation data (e.g. 113, 123, 133, 145 and 147) should be added to a library is determined in step 155.

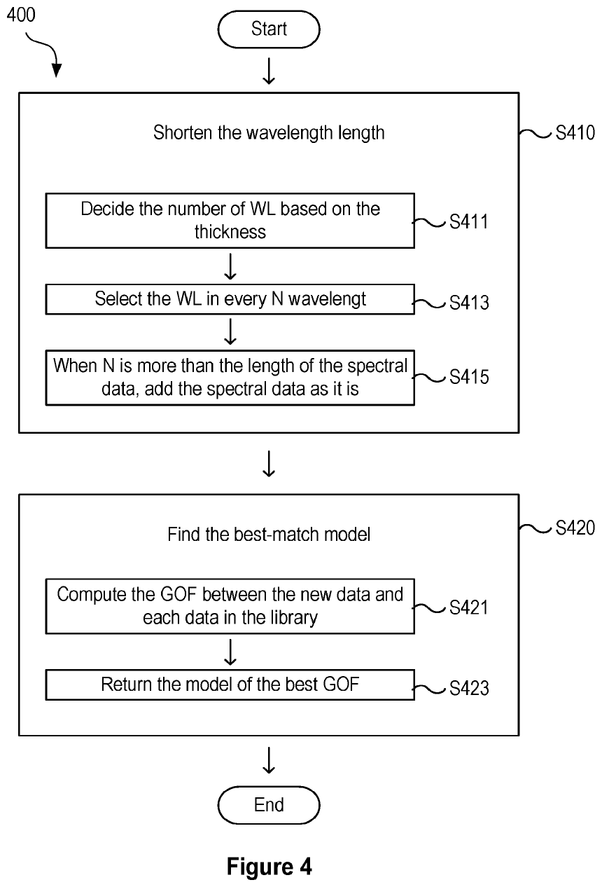

In step 107, whether the transformed data 105 are the first data is determined. If the transformed data 105 are not the first data, meaning that there are prior data, the transformed data 105 are compared with existing data in the dynamic library 157 to identify a best-match model in step 159 to be used as the multi-layer model 111, one embodiment of which can be further explained in a flow chart of a process 400 in FIG. 4.

As step S410, wavelength length is shortened. Specifically at step S411, the number of wavelengths is decided based on the thickness of the top layer 821. For example, the larger the thickness of the top layer 821 is, the larger the number of wavelengths tends to be.

At step S413, a wavelength in every N wavelengths is selected. For example, a spectrum may be collected at every nanometer from 300 nm to 900 nm, that is at 300 nm, 301 nm, 302 nm, 303 nm, 304 nm, 305 nm, 306 nm . . . . A user may choose to set N=3 so that the spectrum is reduced to 300 nm, 303 nm, 306 nm, 309 nm . . . .

At step S415, when N is more than the length of the spectral data, add the spectral data as it is. For example, when N=70 is set for a spectrum collected at every nanometer from 500 nm to 550 nm, the spectrum is added as it is and will not be shortened.

As step S420, a best-match model is identified. Specifically at step S421, GOF between new data, such as the transformed data 105, and existing data are computed.

At step S423, a model of the best GOF is returned as the best-match model. Such search can be stopped early if a GOF>0.95 is identified. That is, if a model having a GOF>0.95 is identified, this model will be returned as the best-match model, without computing GOF for other models or data. It should be understood that the threshold can be application dependent and is not limited to 0.95.

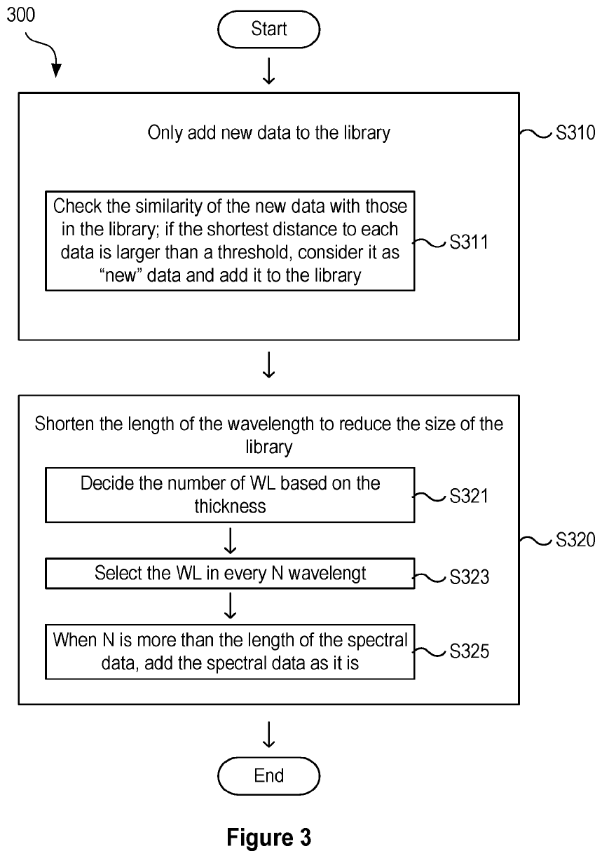

FIG. 3 shows a flow chart of a process 300 of building a library such as the dynamic library 157 in accordance with some embodiments of the present disclosure. The process 300 can reduce redundancy and control size of the dynamic library.

At step S310, only new data are added to the library, similar to step 155. For example, similarity of newly received data with existing data in the library are determined. If the shortest distance from the newly received data to the existing data is larger than a threshold, then the newly received data are considered new and thus added to the library. Otherwise, if the shortest distance from the newly received data to the existing data is smaller than the threshold, it means that the newly received data are similar to some existing data and thus not considered new. Additionally, a dynamic library can be a single library for the multi-layer model, or a library with two sub-libraries, one for the multi-layer model and the other for the modified multi-layer model. The new data will be added to the library corresponding to the model. Theoretically, the number of sub-libraries can be more than two.

At step S320, the length of the wavelength can be shortened to reduce the size of the library. Specifically at step S321, the number of wavelengths is decided based on the thickness of the top layer 821. For example, the larger the thickness of the top layer 821 is, the larger the number of wavelengths tends to be.

At step S323, a wavelength in every N wavelengths is selected. For example, a spectrum may be collected at every nanometer from 300 nm to 900 nm, that is, at 300 nm, 301 nm, 302 nm, 303 nm, 304 nm, 305 nm, 306 nm . . . . A user may choose to set N=3 so that the spectrum is reduced to 300 nm, 303 nm, 306 nm, 309 nm . . . .

At step S325, when N is more than the length of the spectral data, add the spectral data as it is. For example, when N=70 is set for a spectrum collected at every nanometer from 500 nm to 550 nm, the spectrum is added as it is and will not be shortened.

Referring back to FIG. 1, a controller 161 may optionally be included in the process 100. Components of the process 100 can be connected to and controlled by the controller 161 that may optionally be connected to a corresponding memory storage unit and a user interface (e.g. the user interface 153 or a separate user interface) (not all shown). Various operations can be executed via the user interface, and various data and operations can be stored in a storage unit.

It will be recognized that the controller 161 may be coupled to various components of the process 100 to receive inputs from and provide outputs to the components. For example, the controller 161 can be configured to receive the measurement data 101, execute data transformation and output the transformed data 105. The controller 161 can also be configured to implement steps 115, 121, 131, 141, 157, 159 and/or the like. For example, the controller 161 can implement step 131 by adjusting the starting thickness. Of course, one or more functions of the controller 161 can also be manually accomplished.

The controller 161 can be implemented in a wide variety of manners. In one example, the controller 161 is a computer. In another example, the controller 161 includes one or more programmable integrated circuits that are programmed to provide the functionality described herein. For example, one or more processors (e.g. microprocessor, microcontroller, central processing unit, etc.), programmable logic devices (e.g. complex programmable logic device (CPLD)), field programmable gate array (FPGA), etc.), and/or other programmable integrated circuits can be programmed with software or other programming instructions to implement the functionality of a proscribed plasma process recipe. It is further noted that the software or other programming instructions can be stored in one or more non-transitory computer-readable mediums (e.g. memory storage devices, FLASH memory, DRAM memory, reprogrammable storage devices, hard drives, floppy disks, DVDs, CD-ROMs, etc.), and the software or other programming instructions when executed by the programmable integrated circuits cause the programmable integrated circuits to perform the processes, functions, and/or capabilities described herein. Other variations could also be implemented.

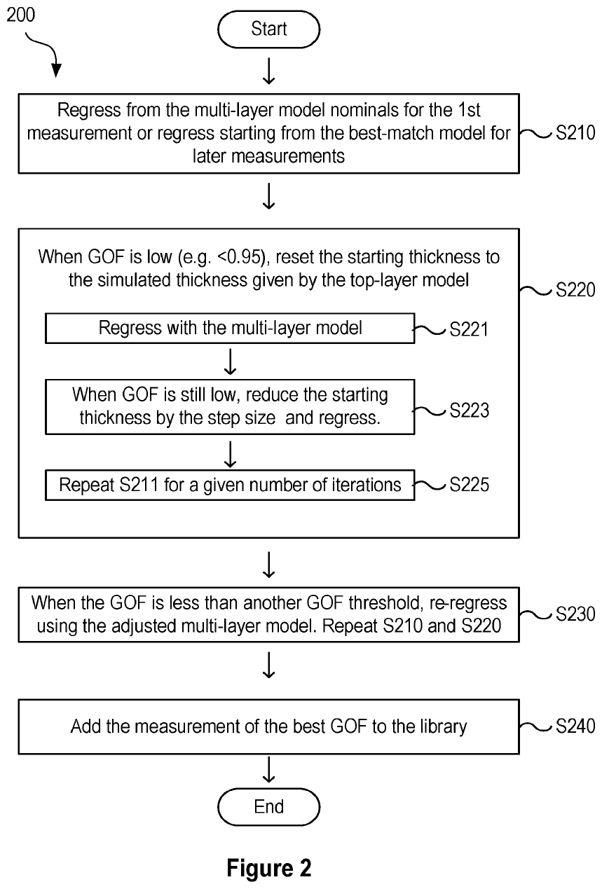

FIG. 2 shows a flow chart of a process 200 of regressions to obtain a thickness in accordance with some embodiments of the present disclosure. At step S210, a user may regress from the multi-layer model nominals for the first measurement or regress starting from the best-match model for later measurements.

At step S220, when GOF is low (e.g. <0.95), the starting thickness of the multi-layer model 111 can be set to the simulated thickness given by the top-layer model. Specifically at step S221, a user may regress with the multi-layer model 111. At step S223, when the GOF is still low, the starting thickness of the multi-layer model 111 can be reduced by the step size for regressions.

At step S225, a user may repeat step S221 for a given number of iterations. A user may stop the iterations early, for instance if the GOF is larger than 0.95. Accordingly, a user may take the corresponding regression results. Otherwise, a user can take the best results from the multiple local regressions.

At step S230, when the GOF is less than another GOF threshold, a user can re-regress using the adjusted multi-layer model 143. A user may optionally choose to repeat step S210 and step S220.

At step S240, the measurement of the best GOF is added to the library.

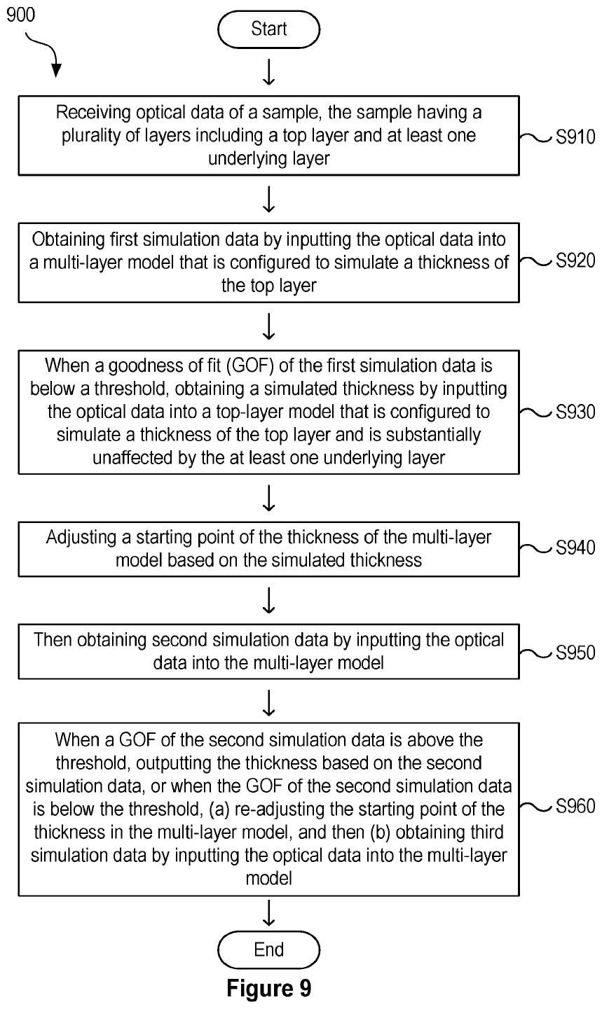

FIG. 9 shows a flow chart of a process 900 for determining film thickness, in accordance with some embodiments of the present disclosure. At step S910, optical data of a sample are received. The sample has a plurality of layers including a top layer and at least one underlying layer. At step S920, first simulation data are obtained by inputting the optical data into a multi-layer model that is configured to simulate a thickness of the top layer. At step S930, when a goodness of fit (GOF) of the first simulation data is below a threshold, a simulated thickness is obtained by inputting the optical data into a top-layer model that is configured to simulate a thickness of the top layer and is substantially unaffected by the at least one underlying layer. At step S940, a starting point of the thickness of the multi-layer model is adjusted based on the simulated thickness. At step S950, second simulation data are then obtained by inputting the optical data into the multi-layer model. At step S960, when a GOF of the second simulation data is above the threshold, the thickness is output based on the second simulation data, or when the GOF of the second simulation data is below the threshold, the starting point of the thickness in the multi-layer model is re-adjusted, and third simulation data are then obtained by inputting the optical data into the multi-layer model.

In the preceding description, specific details have been set forth, such as a particular geometry of a processing system and descriptions of various components and processes used therein. It should be understood, however, that techniques herein may be practiced in other embodiments that depart from these specific details, and that such details are for purposes of explanation and not limitation. Embodiments disclosed herein have been described with reference to the accompanying drawings. Similarly, for purposes of explanation, specific numbers, materials, and configurations have been set forth in order to provide a thorough understanding. Nevertheless, embodiments may be practiced without such specific details. Components having substantially the same functional constructions are denoted by like reference characters, and thus any redundant descriptions may be omitted.

Various techniques have been described as multiple discrete operations to assist in understanding the various embodiments. The order of description should not be construed as to imply that these operations are necessarily order dependent. Indeed, these operations need not be performed in the order of presentation. Operations described may be performed in a different order than the described embodiment. Various additional operations may be performed and/or described operations may be omitted in additional embodiments.

“Substrate” or “wafer” as used herein generically refers to an object being processed in accordance with the invention. The substrate may include any material portion or structure of a device, particularly a semiconductor or other electronics device, and may, for example, be a base substrate structure, such as a semiconductor wafer, reticle, or a layer on or overlying a base substrate structure such as a thin film. Thus, substrate is not limited to any particular base structure, underlying layer or overlying layer, patterned or un-patterned, but rather, is contemplated to include any such layer or base structure, and any combination of layers and/or base structures. The description may reference particular types of substrates, but this is for illustrative purposes only.

The substrate can be any suitable substrate, such as a silicon (Si) substrate, a germanium (Ge) substrate, a silicon-germanium (SiGe) substrate, and/or a silicon-on-insulator (SOI) substrate. The substrate may include a semiconductor material, for example, a Group IV semiconductor, a Group III-V compound semiconductor, or a Group II-VI oxide semiconductor. The Group IV semiconductor may include Si, Ge, or SiGe. The substrate may be a bulk wafer or an epitaxial layer.

Those skilled in the art will also understand that there can be many variations made to the operations of the techniques explained above while still achieving the same objectives of the invention. Such variations are intended to be covered by the scope of this disclosure. As such, the foregoing descriptions of embodiments of the invention are not intended to be limiting. Rather, any limitations to embodiments of the invention are presented in the following claims.

What is claimed is:

1. A method of film thickness modeling, the method comprising:
receiving optical data of a sample, the sample having a plurality of layers including a top layer and at least one underlying layer;
obtaining first simulation data by inputting the optical data into a multi-layer model that is configured to simulate a thickness of the top layer;
when a goodness of fit (GOF) of the first simulation data is below a threshold, obtaining a simulated thickness by inputting the optical data into a top-layer model that is configured to simulate a thickness of the top layer and is substantially unaffected by the at least one underlying layer;
adjusting a starting point of the thickness of the multi-layer model based on the simulated thickness;
then obtaining second simulation data by inputting the optical data into the multi-layer model; and
when a GOF of the second simulation data is above the threshold, outputting the thickness based on the second simulation data, or when the GOF of the second simulation data is below the threshold, (a) re-adjusting the starting point of the thickness in the multi-layer model, and then (b) obtaining third simulation data by inputting the optical data into the multi-layer model.

2. The method of claim 1, further comprising:
when a GOF of the third simulation data is below the threshold, receiving an adjusted multi-layer model in which a fixed constant of the multi-layer model is changed to a variable, a variable of the multi-layer model is changed to a fixed constant, or a combination thereof.

3. The method of claim 2, further comprising:
obtaining fourth simulation data by inputting the optical data into the adjusted multi-layer model.

4. The method of claim 3, further comprising:
when a GOF of the fourth simulation data is below the threshold, adjusting a starting point of the thickness of the adjusted multi-layer model based on the simulated thickness; and
then obtaining fifth simulation data by inputting the optical data into the adjusted multi-layer model.

5. The method of claim 4, further comprising:
when a GOF of the fifth simulation data is below the threshold, (c) re-adjusting the starting point of the thickness of the adjusted multi-layer model; and
(d) then obtaining sixth simulation data by inputting the optical data into the adjusted multi-layer model.

6. The method of claim 5, further comprising:
repeating (c) and (d) until a GOF of the sixth simulation data is above the threshold.

7. The method of claim 2, wherein:
in the multi-layer model, at least one thickness of the at least one underlying layer is a fixed constant, and
in the adjusted multi-layer model, the at least one thickness of the at least one underlying layer is a variable.

8. The method of claim 1, further comprising:
repeating (a) and (b) until a GOF of the third simulation data is above the threshold.

9. The method of claim 1, wherein (a) comprises:
reducing the starting point of the thickness in the multi-layer model.

10. The method of claim 5, further comprising:
obtaining GOFs of the first, second, third, fourth, fifth and sixth simulation data with a cost function.

11. The method of claim 2, further comprising:
receiving a library comprising historic data and historic models including the multi-layer model and the adjusted multi-layer model.

12. The method of claim 11, further comprising:
choosing the multi-layer model from the library by calculating GOFs between the optical data and the historical data and identifying a largest GOF.

13. The method of claim 11, further comprising:
adding the optical data to the library when the optical data have a distance larger than a threshold distance from the historic data of the library.

14. The method of claim 11, wherein the optical data comprise reflectance spectra, the method further comprising:
reducing a library size by reducing the number of wavelengths in the reflectance spectra.

15. The method of claim 1, wherein the top-layer model comprises:
performing a Fourier Transform (FT) of the optical data to obtain an FT spectrum; and
determining the thickness based on a primary peak of the FT spectrum which has a highest value in the FT spectrum.

16. The method of claim 1, wherein the optical data of the sample comprises optical data of reflectance versus wavelength.

17. The method of claim 16, wherein receiving the optical data of the sample comprises:
measuring the sample to obtain measurement data of intensity versus wavelength; and
converting the measurement data of intensity versus wavelength to the optical data of reflectance versus wavelength.

18. The method of claim 1, wherein:
the multi-layer model is an optical spectral model.

19. The method of claim 1, wherein:
the top layer comprises silicon, and
the at least one underlying layer includes silicon oxide and another layer.

20. An apparatus, comprising:
a controller including a processor that is programmed to:
measure data associated with a plasma-related process using a plurality of sensors while executing the plasma-related process on a wafer;
receive optical data of a sample, the sample having a plurality of layers including a top layer and at least one underlying layer;
obtain first simulation data by inputting the optical data into a multi-layer model that is configured to simulate a thickness of the top layer;
when a goodness of fit (GOF) of the first simulation data is below a threshold, obtain a simulated thickness by inputting the optical data into a top-layer model that is configured to simulate a thickness of the top layer and is substantially unaffected by the at least one underlying layer;
adjust a starting point of the thickness of the multi-layer model based on the simulated thickness;
then obtain second simulation data by inputting the optical data into the multi-layer model; and
when a GOF of the second simulation data is above the threshold, output the thickness based on the second simulation data, or when the GOF of the second simulation data is below the threshold, (a) re-adjust the starting point of the thickness in the multi-layer model, and then (b) obtain third simulation data by inputting the optical data into the multi-layer model.
